(19) United States
(12) Patent Application Publication
(10) Pub. No.: US 2002/0032591 A1
(43) Pub. Date: Mar. 14, 2002

(54) Service request processing performed by artificial intelligence systems in conjunctiion with human intervention

(75) Inventors: Kevin E. Mahaffy, Fresno, CA (US); David B. Mahaffy, Fresno, CA (US); Eric E. Schmidt, Hesperia, CA (US)

Correspondence Address: David P. Gordon, Esq., 65 Woods End Road, Stamford, CT, 06905, US

(73) Assignee: agentAI, Inc.

(21) Appl. No.: 09/739,572

(22) Filed: Dec. 18, 2000

Related U.S. Application Data
(63) Continuation-in-part of application No. 09/657,719, filed on Sep. 8, 2000.

(51) Int. Cl. G06F 17/60; G06N 5/00; G06F 17/00

(52) U.S. Cl. 705/8; 705/9; 706/45

(57) ABSTRACT

A virtual assistant system for information retrieval and management and service request processing includes a user interaction device (UID), a server computer, a system computer, and a human-controlled call center. The UID permits the user to provide voice or written instructions to the system computer via the server computer. The system computer runs artificial intelligence (AI) routines to process or preprocess commands provided into the UID by the user. When possible, the AI routines complete the requested service. Where the AI routines alone are insufficient, a human-controlled call center corrects and completes the service requests. Skilled human labor, then, is only relied upon when needed by the system. A great range of service requests can be made including, e.g., voice recording, custom form filling, speech and handwriting text conversions, information retrieval, contact management, list making, reservation making, reminder services, receptionist services, fax, email, and electronic document sending and retrieval.

This application is a continuation-in-part of U.S. Ser. No. 09/657,719, filed Sep. 8, 2000, which is hereby incorporated by reference herein in its entirety.

### BACKGROUND OF THE INVENTION

1. Field of the Invention

This invention relates broadly to data processing. More particularly, this invention relates to service request processing in which artificial intelligence systems are used in conjunction with human supervision.

2. State of the Art

The responsibilities incumbent on business executives, physicians, attorneys and other professional are great. There are meetings to arrange and attend, travel reservations to make, phone calls to return, forms and reports to complete, facsimiles to send and review, documents to type, email correspondence, etc. In order to manage time effectively, such professionals often employ one or more assistants to complete many of these tasks, thereby making available valuable time for the professional.

However, the labor costs for assistants are expensive, and assistants only work for a limited number of hours each day. Thus, the professional frequently has had to tailor his or her schedule to the schedule of the assistant, or do without such assistance at times of need.

Recently, with the growth of the Internet, various ‘virtual’ secretarial service companies have been offered which purport to provide the skills of a secretary on an as-needed basis. However, these companies offer services which are rudimentary at best and function similar to a remote temporary service. That is, the skills offered are generally limited to typing and the like. In addition, the services tend to be relatively expensive, as they rely on human labor.

Services also exist on the Internet which deliver non-secretarial, personalized information retrieval services to users. For example, iNetNow™ relies on “professional Internet search experts” to provide person-to-person information retrieval. However, the cost of running such a computer service is very expensive due to the high degree of training required for the workers and the requirement for workers who also excel at front end customer service. These companies have a difficult time establishing a profitable business model in view of their high labor costs.

For some tasks, such as the transcription of spoken words into typed documents, there has been some success with computer systems which perform automated processing. For example, speech recognition software has advanced in recent years. However, such software is not yet perfected. That is, the software is not yet at a level of development, and likely will not be for some time, at which the recognition algorithms consistently provide an error-free transcription of the spoken words. This is very important as the users of such software, and particularly professionals, do not want to send documents to others which contain embarrassing, if not costly, errors, and cannot forfeit the time required to proofread all documents.

Another type of automated system is exemplified by PORTICO™ by General Magic. PORTICO™ purports to be able to automatically forward telephone calls, direct facsimiles, manage messages, provide access to news all through voice command over a telephone, and perform a host of other functions through reliance on speech recognition and text to speech technologies. However, the functionality of PORTICO™ functionality is limited to understanding short, generally single word, commands. The simple command “call Bob Williams” is within the realm of service capability, while “make a reservation at the restaurant ‘21’ for four at eight tonight and call me back with a confirmation” presumably would not be understood or processed due to the complexity of the sentence and a request for service outside the scope of the technology.

### SUMMARY OF THE INVENTION

It is therefore an object of the invention to provide a system which reliably retrieves information and reliably carries out complex requested commands.

It is another object of the invention to provide a system which is available twenty-four hours a day, and accessible from anywhere in the world.

It is an additional object of the invention to provide a system which offers numerous services and can complete numerous requests.

It is a further object of the invention to provide a system which has lower associated costs than a system which is limited to solely using skilled workers to process each service request.

It is also an object of the invention to provide a system which is at least partly automated, but is not limited by the current state of the art of voice recognition, speech to text software, and other automated intelligent systems.

In accord with these objects, which will be discussed in detail below, a virtual assistant system for information retrieval and management and service request processing is provided. The system includes a user interaction device (UID), a server computer, a system computer, and a human-controlled call center. The UID is provided with an audio speaker, a microphone, and optionally a pressure sensitive screen for reading the movement of a stylus thereacross. The server computer is a network node adapted to communicate with a user through the UID, digitize voice signals from the UID, and transmit and receive digitized voice and data in packets, e.g., IP packets, over the Internet or other computer network to the system computer. The system computer performs user identification, performs billing routines, and runs artificial intelligence (AI) routines to preprocess and process requests (commands) provided from an input device of the UID. When possible, the artificial intelligence routines complete the service requested by the user through the UID.

However, it is recognized that current state of the art artificial intelligence alone may not be sufficient to satisfactorily complete all service requests which may be given by a user to the system via the UID. As such, the human-controlled call center completes, corrects or verifies service requests and the results of service requests that cannot be satisfactorily completed by the artificial intelligence routines alone. Skilled human labor, then, is only relied upon when needed by the system, and the costs for such labor is thereby reduced. The interaction of personnel at the call center with the user, when necessary, is through audio which is preferably indistinguishable to the user relative to the user's interaction with the artificial intelligence routines of the computer system. That is, the user is preferably unaware of any shortcoming in the artificial intelligence processing and perceives the service request processing as one continuous interaction even if the human-controlled call center is utilized.

A great range of service requests can be made by the user to the system. For example, voice recording, custom form filling, speech to text conversion, handwriting to text conversion, information retrieval, contact management, list making, reservation making, reminder services, receptionist services, fax, email and electronic document sending and retrieval, and anonymous purchasing agent services, among other services, can all be performed. The system provides a very reliable ‘virtual assistant’ which processes the service request and is particularly suitable for use by professionals, but usable by anyone requiring or wanting the services available from the system.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic of the system of the invention;

FIG. 2 is a schematic of a flow chart of a general overview of the system processing of the invention;

FIG. 3 is a flow chart of the processing by the virtual assistant system of an email service request;

FIG. 4 is a flow chart of the processing by the virtual assistant system of a list-making service request;

FIG. 5 is a flow chart of the processing by the virtual assistant system of a reservation email service request;

FIG. 6 is a flow chart of the processing by the virtual assistant system of a private purchase request; and

FIG. 7 is a flow chart of the processing by the virtual assistant system of a form filling service request.

### DETAILED DESCRIPTION OF THE PREFERRED EMBODIMENTS

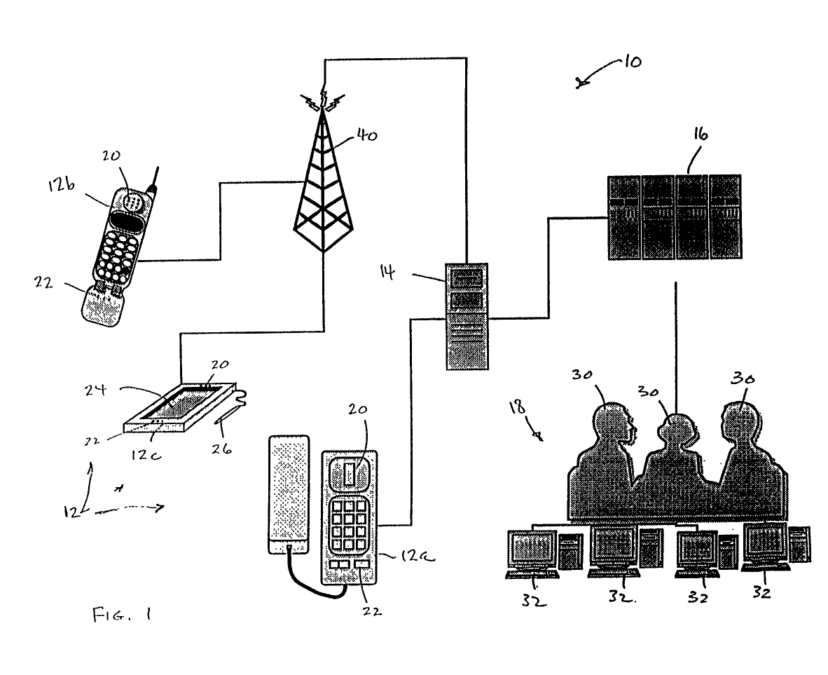

Turning now to FIG. 1, a virtual assistant system 10 for information retrieval and management and service request processing is provided. The system 10 includes one or more user interaction devices (UID) 12a, 12b, or 12c (collectively referred to as 12), a server computer 14 in communication with the UIDs 12, a system computer 16 in communication with the server computer 14, and a human-controlled call center 18 in communication with the processing computer system 16. As discussed in more detail below, each of the system computer 16 and the personnel at the call center 18 can communicate with the user through respective UIDs 12.

Each UID 12 is provided with an audio speaker 20 and a microphone 22. Preferred UIDs 12 include landline telephones 12a, mobile telephones 12b, and small computing devices such as the handheld computers available from Palm Inc. and Handspring and other competing products. The UID may optionally include a pressure sensitive screen 24 for reading the movement of a stylus 26 thereacross, as shown with respect to computing device 12c.

The server computer 14 is a network node adapted to receive signals from and send signals to the UID 12, digitize analog voice signals from the UID, transmit and receive digitized voice and data in packets, e.g., IP packets, over the Internet or other computer network to the system computer 16, and decode digitized voice signals for transmission to an analog UID 12.

The system computer 16 performs user identification, runs voice recognition (VR) and artificial intelligence (AI) routines to preprocess and process requests (commands) provided from the input device (e.g., microphone 22 or screen 24) of the UID 12, and controls billing routines. The communication between the user and an interactive routine of the system computer 16 is preferably in a natural language discourse. When possible, the speech recognition and, if necessary, artificial intelligence routines preprocess requests by the user to determine the type of service being requested (e.g., dictation and transcription, email, information retrieval, form filling, reservation making, etc.). Then, AI routines (incorporating more sophisticated speech processing systems) process the request preferably through to completion. The ability of the AI routines to satisfactorily process (and preprocess) the user requests depends on the amount of variability present in the process; i.e., the extent to which the vocabulary, grammar, and even voice accents used in the interaction varies from one user to another. The AI routines are preferably optimized based on conditioning data collected from sample requests, and then used to train the AI routines. AI routine training and optimization is preferably performed on a continual basis, with reports of misunderstood requests regularly analyzed and used to improve the performance of the system.

An important issue for automating user requests made over UID is to distinguish between customer-UID interaction speech and other speech, e.g., utterances by the user to other people in the vicinity, background radio noises, or even “talking to oneself”. One simple approach to overcome this difficulty is to ‘track’ speech only in response to a system inquiry; i.e., the processing computer system 16 asks the user “What service would you like performed?” and receives the user's direct response.

Current speech recognition systems are effective in one of two modes: either there is a single speaker, for which the system can be individually trained to understand a relatively large vocabulary; or there can be multiple speakers for which current systems can recognize a limited vocabulary. For the system of the invention, the vocabulary required for recognizing the type of request, i.e., preprocessing, is likely to be quite limited, thereby making high-accuracy speech recognition feasible for use by multiple users. For example, in an application of a restricted-domain automated dialogue system, a vocabulary of five hundred words was sufficient. See J. Gustafson, N. Lindberg, and M. Lundeberg, “The August Spoken Dialogue System”, Proceedings of Eurospeech '99 (1999).

Currently existing on the market are several high-quality commercial speech recognition systems: Dragon's NaturallySpeaking™, Kurzweil Applied Intelligence's L&H Voice Xpress™, and IBM's ViaVoice™. These speech recognition systems are primarily designed for single speaker, large vocabulary settings. However, the systems may be modified for use in a multiple speaker, limited vocabulary setting. Another option is to utilize a speech recognition tool kit with a developer's application programming interface (API) that allows the vocabulary and other aspects to be tailored to the fast food ordering process (See http://www.speech.cs.cmu.edu/comp.speech/FAQ.Packages.html for links to available packages). In addition, an existing public domain speech recognition system may be adapted, or a system may be implemented from scratch. See Gustafson et al. (1999) for details on how this can be done.

Another important issue is the ability of the voice speech and AI routines of the system computer 16 to recognize when the result of the speech recognition is correct and, when it is incorrect, to cause the system to ask the customer for a clarification or cause intervention by personnel at the call center 18, as described further below. Several approaches can be used for estimating this confidence. All current speech recognition and AI systems use an underlying probabilistic model, so they can be adapted to output the probability of the acoustic signal given the recognized words. In other words, this number estimates how likely this particular word sequence is to have generated the acoustic signal heard. If this number is low, this is an indicator of possibly faulty recognition. A possible improvement to this approach is to also generate a second probability of the acoustic signal given a syllable-based recognition system that does not try to match words. See Gustafson et al. (1999). If the second probability is substantially higher than the first, then the utterance contained words outside the vocabulary of the speech recognition system's lexicon that the system “forced” into words in the lexicon. That is, the current system preferably calculates a probability that not just the user's words, but the user's overall intent have been understood. If not, clarification is requested.

The user's service request may be processed by the AI routines according to one or more of several approaches. Each approach is of increasing complexity on the one hand, but typically higher accuracy rates on the other. The simplest approach is to use no semantic processing, just recognition of basic ‘request’ items. In this case, the analysis is a direct result of the speech recognition. If one recognizes the word “dictation”, this is interpreted as a request for dictation and transcription services.

A second level is to generate a corpus of utterances that are likely to occur in a user request. One can then compare the user request to others in the database, and find the closest match. This is the approach discussed in Gustafson et al. (1999). A semantic interpretation, i.e., a mapping between the sentence structure and an order form, can then be manually constructed for each template sentence. The extent to which this approach can be successful depends, as discussed above, on the variability of utterances that occur.

The next level is to actually parse the request sentences using some type of grammar. There has been substantial improvement in the last five years in parsing (See C. Manning and H. Schütze, Foundations of Statistical Natural Language Processing, MIT Press (1999)), including a recent account of parsing a large corpus of speech utterances. See E. Charniak, “The Statistical Natural Language Processing Revolution”, colloquium talk given at Stanford University, Apr. 26, 2000 (see http://robotics.stanford.edu/ba-colloquium/previous/spring00/abstcharniak.html). The parsing uses a grammar, preferably learned automatically from a corpus of utterances parsed manually. As discussed in L. Bell and J. Gustafson, “Interaction with an Animated Agent in a Spoken Dialogue System”, Proceedings of Eurospeech '99 (1999), the number of grammatical variations in automated dialogue systems is usually quite small, and the grammar is quite simple. Again, it is easiest to manually provide a semantic interpretation for each grammatical structure, as above.

A difficult problem is the treatment of anaphoric references, of the form: “Email the document to Kevin Smith. Actually, don't email it to Kevin Smith. Instead, send it to his fax number instead.” It is difficult to relate the word “it” to the “document” and to process the change in request from email to fax. There has been some success in automatically clarifying anaphoric references (See E. Charniak, N. Ge, and J. Hale, “A Statistical Approach to Anaphora Resolution”, Proceedings of the Sixth Workshop on Very Large Corpora (1998)), but this is still a difficult problem. As such, the AI routines are preferably adapted to clarify the references by having the system computer ask the user via the UID “What do you mean?” or “Please repeat what you would like me to do.”

If the AI routines are able to recognize and parse the speech of the user (as preferably determined via a probabilistic calculation) such that the requests are properly categorized for processing, the user request is preferably confirmed by digitized voice to the user by the processing system; i.e., “I am ready to take your dictation and fax a copy of the transcription to Mike Smith”. Known smoothing techniques are preferably used to provide a natural sounding transition between the reproduced words.

However, it is recognized that current state of the art of artificial intelligence alone may not be sufficient to satisfactorily preprocess, let alone process to completion, all service requests which may be given by a user to the system computer 16 via the UID 12. As such, if anaphoric phrases or other problems cannot be resolved by the AI routines, a worker 30 at the call center 18 corrects, completes, and/or verifies, as necessary, the processing of the service requests. Skilled human labor 30, then, is only relied upon when needed by the AI system, and the costs associated with human skilled labor is thereby reduced.

The workers 30 of the call center 18 are each provided with a computer 32 in communication with the system computer 16 (which is in communication with the user's UID 12). The interaction of a worker with a user, when necessary, is preferably through audio and is preferably indistinguishable to the user relative to the user's interaction with the artificial intelligence routines of the system computer 16. That is, the user is preferably unaware of any shortcoming in the artificial intelligence processing and perceives the service request processing as one continuous interaction even if the call center is utilized. In addition, as the user is preferably unaware of the location of the call center 18 and does not directly interact with the workers 30 at the call center (all interaction is preferably through text converted into a digitized voice, text, or other computer generated communication), the call center may be located at a distance from the user, e.g., off-shore, using reduced-cost skilled workers from abroad.

A great range of service requests can be made by the user to the system. For example, dictation, custom form filling, speech to text conversion, handwriting to text conversion (with respect to digitized handwriting on the screen 24 of the UID 12c or a document sent to the virtual assistant system via facsimile), information retrieval, contact management, list making, reservation making (travel, dining, concerts, etc.), reminder services, receptionist services, voice mail, fax, email and electronic document transmission and retrieval, and anonymous purchasing agent services, among other services, can all be performed.

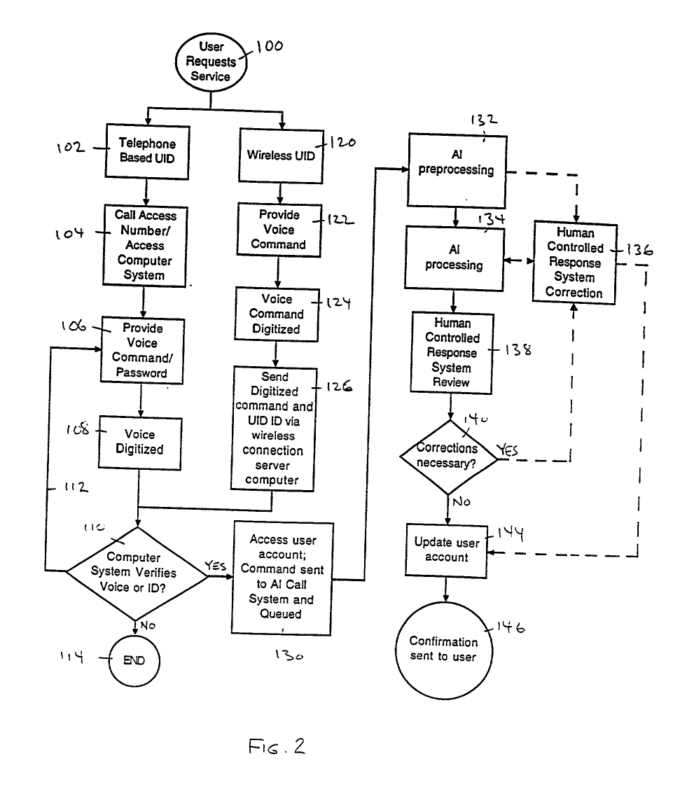

The method of the invention will now be described generally, and then specific examples will be described thereafter. Referring to FIGS. 1 and 2, a user decides at 100 that he or she needs a service to be performed by the virtual assistant system 10. If the user is using a landline telephone 12a at 102, the user calls at 104 an access telephone number which places the user in communication with the server computer 14. The user then makes a request at 106 which is digitized at 108. The server computer 14 accesses the system computer 16, and the digitized voice request is compared at 110 with a voice print stored in the system computer 16 to verify the identity of the user. Alternatively, a password or other positive identification means can be used to verify the identity of the user. If the identity cannot be confirmed at 110, a message stating such is provided by the system computer (via the server computer) to the user, and the user may be given another opportunity at 112 to provide a request, a password, or other manner of identification. Alternatively, e.g., after several failed attempts at positive identification, the user session may be terminated at 114 by the system computer.

If the user is using a wireless UID 12b, 12c at 120, the user provides at 122 a voice request into the UID and the voice request is digitized at 124. The digitized request is then sent at 126 along with a user identifier (e.g., encrypted identification number or a digital security certificate) via a wireless connection to the server computer 14. The wireless data may be transmitted to and retransmitted by a cellular relay tower 40 to the server computer 14 (FIG. 1). The server computer 14 then contacts the system computer 16 to confirm the identity of the user at 110. Failure to confirm preferably leads to session termination at 114.

Once the user is confirmed as a client of the virtual assistant system 10 at 110, the user account is accessed on the system computer 16 and a user identifier is associated with the service request throughout the service request processing steps. In addition, time/date stamp data is preferably associated with the request. The service request is then sent at 130 to the system computer 14 for preprocess queuing; that is, requests are preferably queued for processing in the order in which they are received. Such FIFO processing is facilitated by the time/date stamp data. While it is preferred that there be no delay in request processing, should there be high traffic on the system, requests are processed by the system in the order in which they are received. Once the request is moved through the queue to the front of the line, the request is preprocessed.

Preprocessing is the step by which the AI routines determine the type of service requested by the user in advance of actual performance of the service and enables an appropriate processing interaction with the user. This is preferably done using voice recognition techniques, with an emphasis placed on word spotting, and, if necessary, more sophisticated AI processing. Once the type of service is determined by preprocessing at 132, appropriate AI routines for service processing are then used at 134. As briefly discussed above, if at any time during the preprocessing or processing the voice recognition and AI routines are unable to satisfactorily complete the service request, the system computer 16 communicates with a worker computer 32 at the call center 18 and transmits the digitized voice command thereto. A skilled worker 30 then preprocesses the service request at 136, as required.

If a system error occurred during preprocessing, after the error has been corrected by the skilled worker at the call center, the request is directed to the appropriate AI processing routines. If an AI processing error occurs during request processing, the worker makes the appropriate corrections. Control of the processing may then be returned to the appropriate AI processing routines of system computer 16. Alternatively, where the request can be completed quickly by the skilled worker, or where the skilled worker anticipates that the AI routines will have additional problems, the skilled worker may complete the service request. Additionally, even when the AI routines indicate a satisfactory completion of a service request, a skilled worker at the call center 18 preferably, though optionally, reviews at 138 the results of the AI processing for quality control. If any changes need to be made at 140, the worker 30 at the call center 18 makes such changes at 136 and completes the service request. Finally, the account of the user is updated at 144 for billing and a confirmation is sent at 146 to the user, e.g., a digitized voice message over the telephone or by email. Account information and all work product resulting from processed service requests are preferably accessible by the user on a preferably secure web site.

According to a preferred aspect of the invention, whenever a call center worker is involved in correcting or reviewing the preprocessing or processing of requests, the worker preferably is not made aware of the identity of the user such that user privacy is preserved. A generic, codified, or encrypted user indicator may be seen by the worker, which is linked with the user name from a user account file or decrypted in correspondence with and final request servicing product for the user. In any case, the worker is preferably unable to view the user identity. Moreover, all communications between the user and the system are preferably encrypted for user privacy.

Several examples follow which more specifically detail the preprocessing and processing operations with respect to individual service requests. The examples are in no way meant to be limitations on the type of services which may be provided, nor the exact manner in which such services may be preprocessed and processed. In addition, the examples will be described from a time after the user has made his or her request, the system computer 16 has verified the identity of the user, and at the time the service request is active within the queue.

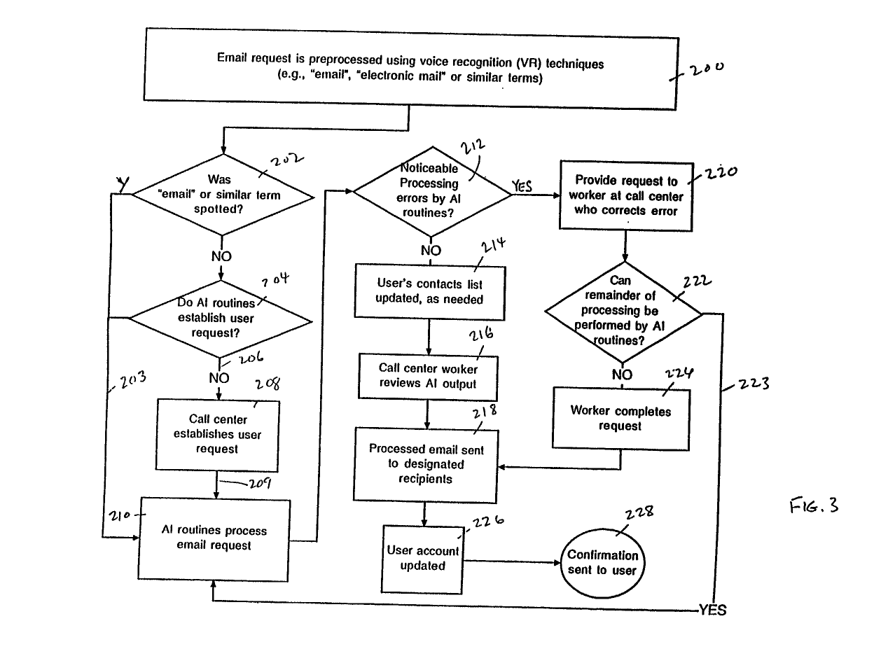

Turning now to FIG. 3, according to a first example, a user requests to send an email to an individual. Voice recognition algorithms in the system computer 16 are used at 200 to preprocess the request to determine the type of requested service. Emphasis is preferably placed at 202 on word-spotting. If terms such as “email” or “electronic mail”, which are considered to indicate the ‘email’ service, are recognized, the requested service is determined with a required level of confidence, and the preprocessing is considered complete at 203. The appropriate AI routines for processing email requests are then used by the system computer to process the request at 210. If voice recognition word spotting is unable to determine with confidence the requested service type, preprocessing AI routines are preferably used at 204 to further discern the requested service. If the preprocess AI routines are successful at determining that the requested service is an email request, the appropriate AI email processing routines are implemented at 210. If the preprocess AI routines are also unable to determine the type of service request, the digitized voice command of the service request is sent at 206 to the call center 18 which listens to the voice command and determines at 208 the type of service requested, i.e., an email to be sent to a third party. The call center then transfers at 209 the service request to the AI processing routines adapted for email.

At 210, the AI routines for email preferably communicate with the user (via the UID), and parse from the digitized voice communication the text for the body of the email, a subject line, and the recipient's email address. When only the recipient's name is provided, and not the email address, the email address may be pulled from a contacts list associated with the user and stored on the system computer. Alternatively, if the email address is a new address, it is preferably added at 214 to the user's contact list. If the AI routines are capable of processing the email service request without error at 212, the email message is then sent at 218 to the designated recipient. Prior to sending, the email message may optionally be reviewed at 216 by a call center worker to verify the correctness of the message.

If there are processing errors at 212 which are noticed by the AI routines, the service request is provided at 220 to a worker at the call center who corrects the error. The worker can then make a determination at 222 as to whether the AI routines can continue processing the email service request. If so, control for processing is returned at 223 to the AI email processing routine 210. If it is determined that the AI routines cannot complete the processing, the worker completes the processing at 224. For example, if the user has a heavy accent which is difficult for the AI routine to process, the worker may decide that it is best to complete processing without returning control for processing the request to the system computer. Once the email has been sent at 218, the user's account is preferably updated (e.g., billed) at 226, and a confirmation that the service request has been satisfactorily completed is preferably sent at 228 to the user.

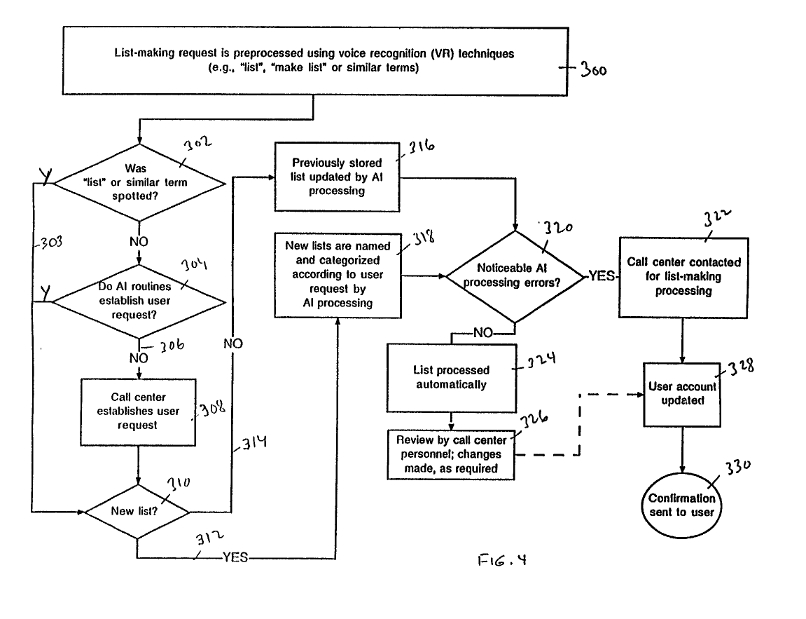

Turning now to FIG. 4, a second example illustrates the processing of a list-making service request. In general, list making is a service in which the virtual assistant system keeps track of items on a ‘to do’ list, items on a shopping list, groups of numbers, names or places, etc. New lists can be created or existing lists can be modified to add or remove items from the list. Lists are available to the user on a world-wide web page assigned to the user by the virtual assistant or by a ‘list-recall’ service request. Additionally or alternatively, the list may also be sent to a desktop or portable computer, a PDA, or similar device, and automatically updated, e.g. via synchronization or emailed events, as items are added.

The service request is preprocessed via voice recognition at 300 and if key ‘list-making’ terms are recognized at 302, the request is presumed at 303 to be for list making. If voice recognition is unable to properly preprocess the request to determine a list-making service is requested at 302, more sophisticated AI routines are utilized 304. Finally, if the AI routines are unable to satisfactorily determine the type of service request at 306, the service request is transferred to the call center at 308.

Once it is determined by one of the preprocessing means that list-making is requested, it must be determined at 310 whether the user is requesting to make a new list at 312 or to modify a preexisting list at 314 by matching the user's request to the titles of lists associated with the user and stored in the system computer database. If an old list is requested to be modified at 314, the list in the database is, at 316, accessed, modified, and stored again. If a new list is to be created at 312, it is titled and categorized and its contents are filled at 318. This, is preferably done via a set of questions by the AI routines, for example, “What do you want to title the list?”, “Please provide the first list item”, etc. Regardless of whether the list is old or new, if at any time during the processing the AI routines are unable to properly process the list-making request at 320, the call center is contacted at 322 and personnel at the call center complete the list creation or modification. Otherwise, the list is processed at 324 to completion automatically by the AI routines. Where processing is completely automated, the call center personnel may nevertheless review at 326 the list-making for quality assurance and make changes as necessary. Once the list-making service request is complete, the user account is updated at 328 and a confirmation is sent to the user at 330.

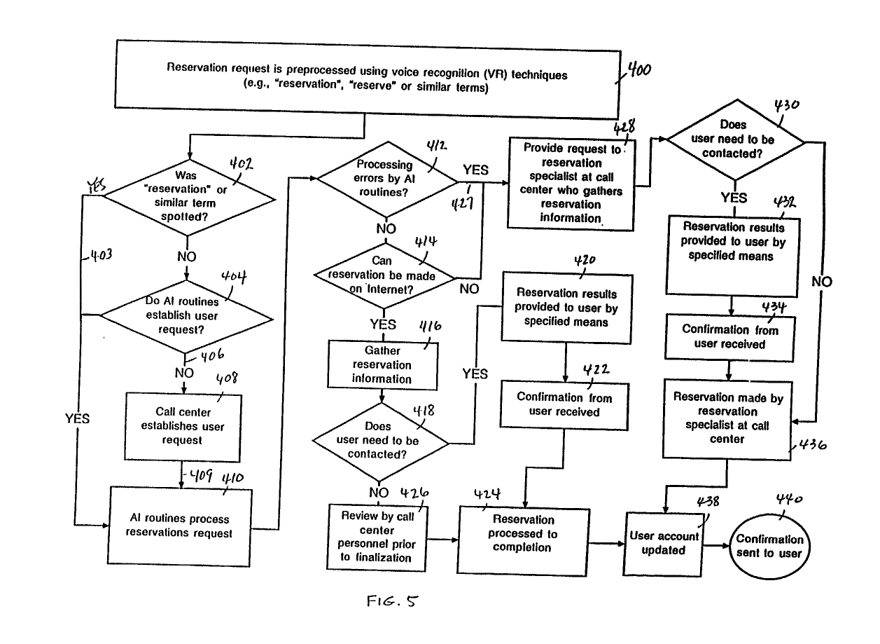

Turning now to FIG. 5, a third example illustrates the processing of a service request for the making of a reservation. Reservations can be for plane tickets, hotels, rental cars, theaters, movie tickets, restaurants, etc.

The service request is preprocessed at 400 through 410 via voice recognition, AI routines, or the call center, as described above with respect 200 through 210 in FIG. 3. Once it is determined that a reservation service is requested, the AI reservation routines take the reservation requirements presented by the user and process the request at 410, including information as to who can or needs to be contacted prior to reservation finalization. If there are no noticeable processing errors at 412, the AI reservation routines determine at 414 whether the reservation is of the type which can be made on the Internet. If the reservation can be made on the Internet at 416, the necessary details are collected: seat availability, price, time, etc. If the AI routines determine at 418 that the user requested that he or she be contacted prior to reservation finalization, the collected reservation results are provided to the user at 420 in a user-specified manner, e.g., by email or voice phone. Once confirmation is received from the user at 422 that a reservation based on the collected terms is acceptable, the reservation is processed to completion at 424 by the AI routines. If the user has not requested to be contacted prior to the reservation finalization, it is preferable that call center personnel review at 426 the collected reservation information and then, if the reservation appears correct, allow the reservation to be finalized at 424.

If there are noticeable processing errors at 412, the service request is transferred at 427 to the call center. A reservation specialist at the call center then gathers at 428 the necessary reservation information. If the user requested (in the service request, or in a user preferences file stored in the system computer) that he or she be contacted prior to finalizing the reservation, the collected reservation information is provided to the user at 432. When the user confirms that the reservation information is acceptable at 434, the reservation is made at 436 by the specialist at the call center. If the user does not require at 430 that he or she be notified of the results prior to finalization, the reservation can be made at 436 without user confirmation. Once the reservation is finalized, the user account is updated and a confirmation is sent to the user.

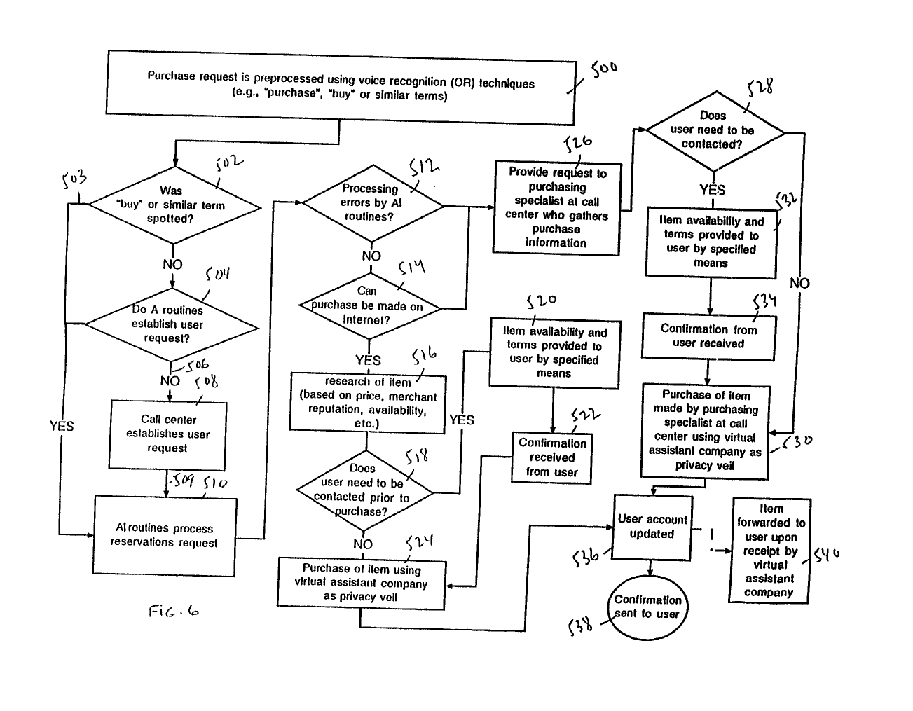

Referring now to FIG. 6, a fourth example illustrates the processing of a ‘purchase’ service request. The virtual assistant functions as a personal shopper. In addition, because the virtual assistant permits purchases to be made on behalf of the user under the corporate identity of the virtual assistant, the identity of the user can be kept anonymous.

The service request is preprocessed at 500 through 510 via voice recognition, AI routines, or the call center, as described above with respect 200 through 210 in FIG. 3. Once the service request is determined to be a purchase request, the appropriate AI ‘item purchase’ routines are utilized at 510 to process the request. If there are no noticeable processing errors at 512, the AI purchasing routines determine at 514 whether the purchase can be made on the Internet. If the purchase can be made on the Internet, at 516 the necessary details are collected: model number, price, availability, merchant rating, etc. If the AI routines determine at 518 that the user requested that he or she be contacted prior to purchase finalization, the collected results for the purchase are provided to the user at 520 in a user-specified manner. Once confirmation is received from the user at 522 that the purchase is acceptable, the purchase is processed to completion at 524 by the AI routines. As discussed above, an option is provided to the user to have the virtual assistant company be an anonymous purchasing agent for the user such that the merchant is unaware of who is the actual purchaser (the user), in contrast to the apparent purchaser (the virtual assistant company). Similarly, if no confirmation is required by the user, the purchase can be made at 524 by the virtual assistant on behalf of the user.

If the AI routines are unable to properly process the purchase request, the purchase request is provided at 526 to a purchasing specialist at the call center who gather the requisite purchase information. If the user does not need to be contacted prior to purchase, the purchase is then made at 530. If the user needs to be contacted prior to purchase, the gathered information is provided to the user at 532, and upon confirmation from the user at 534, the purchase is made at 530.

After the purchase is made at 524 or 530, the user account is updated at 536 and a confirmation is sent at 538 to the user. Then, as discussed above, if the user requested that the purchase remain private and has the virtual assistant company purchase the item, the purchased item is forwarded at 540 to the user upon receipt by the virtual assistant company.

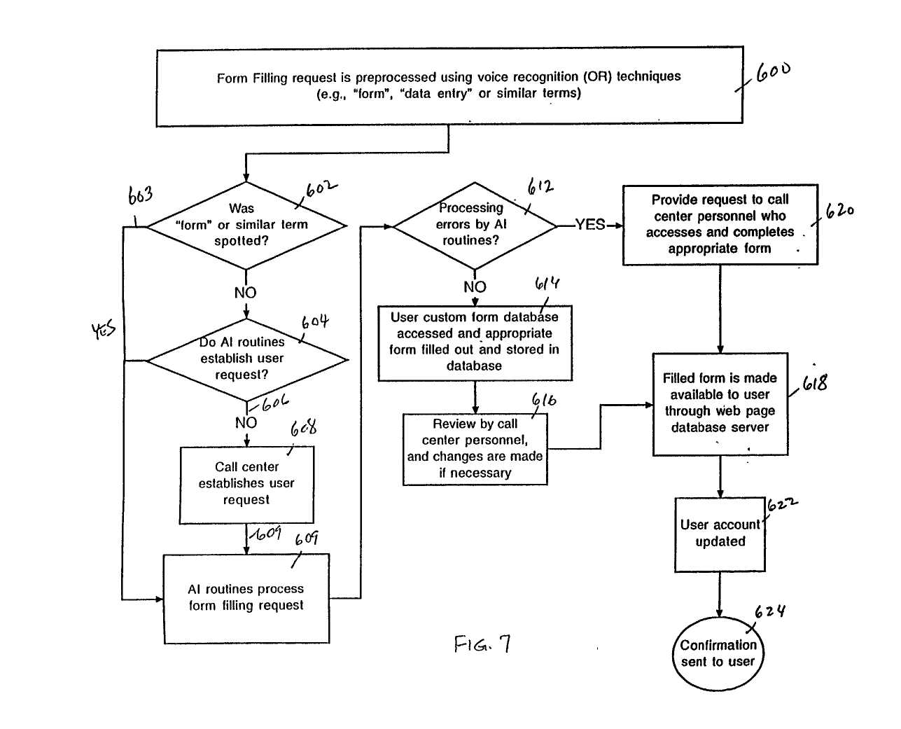

Turning now to FIG. 7, a fifth example illustrates the processing of a ‘form fill’ service request. The form fill request implements data entry into forms selected by the user. The forms may be standard templates (e.g., an expense report), or may be customized (e.g., medical office form tailored to a type of practice). If a customized form is used, the form is preferably customized prior to use by the virtual assistant, e.g., via a form creation or customization tool.

The service request is preprocessed at 600 through 610 via voice recognition, AI routines, or the call center, as described above with respect 200 through 210 in FIG. 3. Once the service request is determined to be a form fill request, the appropriate AI ‘form fill’ routines are utilized at 610 to process the request. If there are no noticeable processing errors at 612, the AI form fill routines access the appropriate forms and one or more records associated with the form are filled out at 614 as provided in the service request preferably through a ‘conversation’ between the user and the system computer. The records are then stored, also at 614, in a database associated with the user. The form and record entry may then optionally be reviewed by call center personnel at 616 to verify that the AI processing has operated correctly. The completed form is then made available at 618 to the user on a dedicated user web page. Alternatively or additionally, the resulting form can be sent via email, facsimile, over the Internet to another database, etc. If the AI routines are unable to properly processes the request, the request is transferred to call center personnel who complete at 620 the appropriate form. The form is then made available to the user at 618. Finally, whether the processing is completed by the AI routines or the call center, the user's account is updated at 622, and a confirmation is sent at 624 to the user, notifying the user that the form data is available.

The system provides a very reliable ‘virtual assistant’ particularly suitable for use by professionals, but usable by anyone requiring or wanting the services available from the system.

There have been described and illustrated herein a virtual assistant system and method of implementing several exemplar features of the system. While particular embodiments of the invention have been described, it is not intended that the invention be limited thereto, as it is intended that the invention be as broad in scope as the art will allow and that the specification be read likewise. This while a single server computer is shown, it will be appreciated that multiple server computers may be used, each being in communication with the system computer. In addition, the system computer may comprise multiple computers located at one or more locations. Furthermore, while several different UIDs are disclosed, other such devices permitting user-to-system communication may be used. Moreover, while particular methods of parsing user speech have been disclosed, other methods may also be used. In addition, while the system computer is described as including the preprocessing routines as well as the processing routines, it will be appreciated that each of the routines may be processed by a distinct computer. Furthermore, while the system of the invention have been described with respect to performing “executive assistant”-type tasks, other tasks benefiting from an artificially intelligent system may also be performed. For example, the system can be configured as a “virtual butler” located at an entrance and similarly adapted to perform useful tasks such as announcing visitors, directing visitors, electronically unlocking doors to approved visitors (approved via facial and/or voice recognition) or upon proprietor command, providing messages to visitors, etc. Likewise, the call center would intervene when necessary due to unsatisfactory preprocessing or processing of visitor and proprietor requests. It will therefore be appreciated by those skilled in the art that yet other modifications could be made to the provided invention without deviating from its spirit and scope as claimed.

1. A virtual assistant system interfacing with a call center having at least one human worker, said virtual assistant system for processing service requests by a user, comprising:
a) a user interaction device (UID) adapted to receive an input from a user; and
b) a system computer in communication with said UID and interfacing with the call center, said system computer including automatic processing means for receiving said input and for processing said input to at least partially recognize a request from the user,
wherein when said automatic processing means is unable to satisfactorily process said request, said call center is contacted by said system computer and a human worker at the call center intervenes to process said request.

2. A virtual assistant system according to claim 1, wherein:
said automatic processing means for processing said input includes artificial intelligence algorithms which process said input.

3. A virtual assistant system according to claim 1, wherein:
said input is a voice signal.

4. A virtual assistant system according to claim 1, further comprising:
d) a server computer which is a node on a global computer network, said server computer in communication with both said UID and said system computer.

5. A virtual assistant system according to claim 4, wherein:
said server computer includes means for receiving said input, converting said input into an IP packet data, and sending said IP packet data over said global computer network to said system computer.

6. A virtual assistant system according to claim 1, wherein:
said UID is one of a landline telephone, a cellular telephone, and a personal digital assistant.

7. A virtual assistant system according to claim 1, wherein:
said automatic processing means also includes preprocessing means for preprocessing said request to determine a type of said request and, based on said type, said request is processed by said automatic processing means.

8. A virtual assistant system according to claim 7, wherein:
said preprocessing means includes a voice recognition algorithm.

9. A virtual assistant system according to claim 7, wherein:
said preprocessing means includes an artificial intelligence algorithm.

10. A virtual assistant system according to claim 1, further comprising:
c) said call center.

11. A virtual assistant system for processing service requests by a user, comprising:
a) a user interaction device (UID) adapted to receive an input from a user;
b) a system computer in communication with said UID and including an artificial intelligence (AI) system which receives said input and processes said input with artificial intelligence routines to at least one of at least partially recognize and at least partially process a request from said input; and
c) a call center including at least one call center computer in communication with said system computer, each said call center computer adapted to be used by a human worker to take control from said AI system and process said request.

12. A method of processing a service request by a user, comprising:
a) inputting the service request to a system computer running artificial intelligence routines;
b) processing said service request by said system computer; and
c) upon determining a problem in said processing, having a human intervene to process said service request.

13. A method according to claim 12, wherein:
said processing includes providing a dialog between said system computer and the user, said system computer using a digitized voice to communicate during the dialog with the user.

14. A method according to claim 12, wherein:
said intervention by the human includes dialog between said human and the user.

15. A method according to claim 14, wherein:
said intervention includes digitizing a voice of the human and transmitting said digitized voice through said system computer to the user.

16. A method according to claim 15, wherein:
said processing includes providing a dialog between said system computer and the user, and said system computer uses a digitized voice to communicate during the dialog with the user,
wherein said digitized voice of said system computer and said digitized human voice sound substantially the same.

17. A method according to claim 12, further comprising:
d) prior to processing said service request, preprocessing said service request to determine a type of said service request.

18. A method according to claim 17, wherein:
said preprocessing is performed by at least one of speech recognition techniques and artificial intelligence techniques.

19. A method according to claim 18, wherein:
when said preprocessing is unable to successfully determine said type of said service request, using human intervention to determine said type of said service request.

20. A method of processing a service request by a user where the service request is made on a user interaction device (UID), said method comprising:
a) inputting a request by the user on the UID;
b) upon receipt of the request, preprocessing the request with a computer system to determine a type of the request;
c) upon determining said type of said request, processing said request with said computer system based upon said type of request; and
d) upon determining a problem in said processing, having a human intervene to process the request.

21. A method according to claim 20, wherein:
said UID is one of a telephone and a computer.

22. A method according to claim 20, wherein:
said computer systems comprise first and second computers.

23. A method according to claim 20, wherein:
said request is input verbally.

24. A method according to claim 20, wherein:
said request is preprocessed to determine said type of said request by using one of speech recognition techniques and artificial intelligence techniques.

25. A method according to claim 24, wherein:
when said preprocessing is unable to successfully determine said type of said service request, using human intervention to determine said type of said service request.

26. A method according to claim 20, wherein:
said processing includes contacting the user for confirmation prior to completing the processing.

27. A method according to claim 20, further comprising:
e) upon substantial completion of said processing, updating user account information.
